(19) United States
(12) Patent Application Publication
(10) Pub. No.: US 2008/0159794 A1
(43) Pub. Date: Jul. 3, 2008

(54) Conveyance apparatus and image forming apparatus

(75) Inventors: Atsuyuki Kitamura, Ebina-shi (JP); Masahiro Sato, Ebina-shi (JP); Junichi Murakami, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/802,034

(22) Filed: May 18, 2007

(30) Foreign Application Priority Data
Dec. 27, 2006 (JP) 2006-351650

(51) Int. Cl. G03G 15/00

(52) U.S. Cl. 399/397

(57) ABSTRACT

A conveyance apparatus includes: a conveyance member that conveys images formed by plural image forming parts or a recording medium on which the images formed by the plural image forming parts are transferred; and a driving unit that drives the conveyance member via a frictional force in at least two positions.

### CROSS-REFERENCE TO RELATED APPLICATIONS

This application is based on and claims priority under 35 USC 119 from Japanese Patent Application No. 2006-351650 filed Dec. 27, 2006.

### BACKGROUND

### Technical Field

The present invention relates to a conveyance apparatus and an image forming apparatus.

### SUMMARY

A conveyance apparatus includes: a conveyance member that conveys images formed by plural image forming parts or a recording medium on which the images formed by the plural image forming parts are transferred; and a driving unit that drives the conveyance member via a frictional force in at least two positions.

### BRIEF DESCRIPTION OF THE DRAWINGS

Exemplary embodiments of the present invention will be described in detail based on the following figures, wherein:

FIG. 1 is a cross-sectional view schematically showing the structure of an image forming apparatus according to a first exemplary embodiment of the present invention;

FIG. 2 is a cross-sectional view showing the structure of an image forming part used in the image forming apparatus according to the first exemplary embodiment of the present invention;

FIG. 3 is a cross-sectional view showing a driving roller used in the image forming apparatus according to the first exemplary embodiment of the present invention;

FIG. 4 is a cross-sectional view showing the structure of a driving transmission mechanism to drive the driving roller used in the image forming apparatus according to the first exemplary embodiment of the present invention;

FIG. 5 is an explanatory view showing the relation between the intervals among respective photoreceptors and the diameter of the driving roller used in the image forming apparatus according to the first exemplary embodiment of the present invention;

FIG. 6 is a cross-sectional view showing the driving roller used in the image forming apparatus according to a second exemplary embodiment of the present invention;

FIG. 7 is a cross-sectional view showing the driving roller used in the image forming apparatus according to a third exemplary embodiment of the present invention;

FIG. 8 is a cross-sectional view showing the driving roller used in the image forming apparatus according to a fourth exemplary embodiment of the present invention;

FIG. 9 is a cross-sectional view showing the driving roller used in the image forming apparatus according to a fifth exemplary embodiment of the present invention;

FIG. 10 is a cross-sectional view showing an intermediate transfer belt used in the image forming apparatus according to a sixth exemplary embodiment of the present invention; and

FIG. 11 is a cross-sectional view schematically showing the structure of the image forming apparatus according to a seventh exemplary embodiment of the present invention.

### DETAILED DESCRIPTION

Next, exemplary embodiments of the present invention will be described based on the drawings.

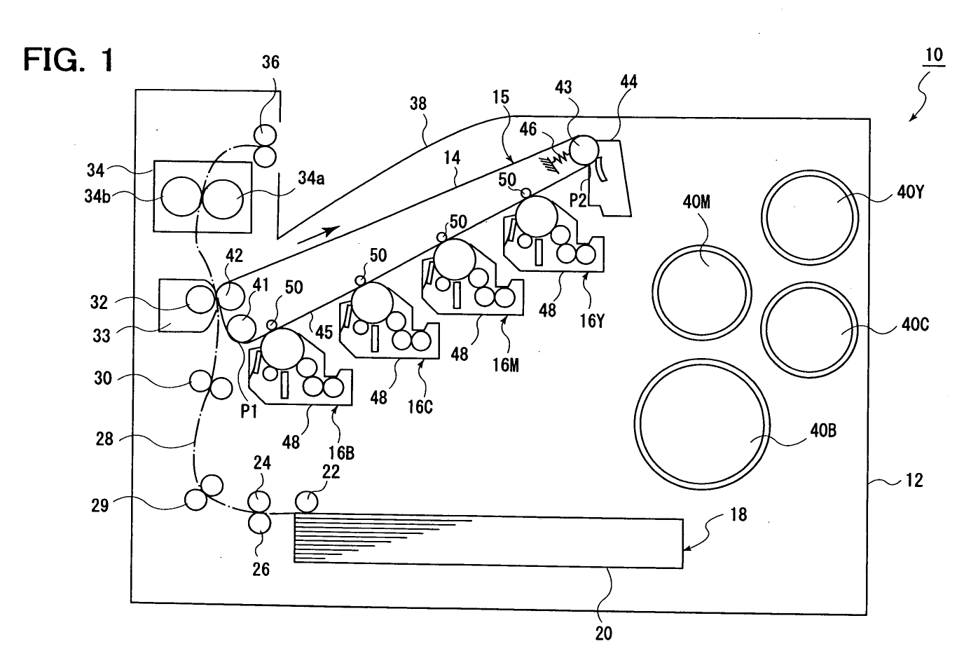

FIG. 1 shows an image forming apparatus 10 according to a first exemplary embodiment of the present invention. The image forming apparatus 10 has an image forming apparatus main body 12 including an intermediate transfer belt 14, a belt unit 15, and plural (e.g. four) image forming parts 16Y, 16M, 16C and 16B. In the present exemplary embodiment, the intermediate transfer belt 14 is used as a conveyance member to convey images formed by the plural image forming parts 16Y, 16M, 16C and 16B, and the belt unit 15 is used as a conveyance device. Further, in the present exemplary embodiment, the image forming parts 16Y, 16M, 16C and 16B which are respectively used as image forming parts are arrayed from an upper right position to a lower left position in FIG. 1. That is, the image forming apparatus 10 is a so-called tandem type apparatus. The image forming part 16Y forms a yellow toner image; the image forming part 16M forms a magenta toner image; the image forming part 16C forms a cyan image; and the image forming part 16B forms a black toner image. The formed toner images are transferred onto the intermediate transfer belt 14.

A sheet feeder 18 is provided in a lower part of the image forming apparatus main body 12. The sheet feeder 18 has a sheet feed cassette 20 on which sheets such as normal paper sheets or OHP sheets are stacked, a pickup roller to pick up the sheets stacked on the sheet feed cassette 20, a feed roller 24 and a retard roller 26 to feed the sheets while separate the sheets. In the present exemplary embodiment, a sheet is used as a recording medium on which the images formed by the image forming parts 16Y, 16M, 16C and 16B are transferred. The sheet feed cassette 20, in which sheets such as normal paper sheets or OHP sheets are set, is detachably attached to the image forming apparatus main body 12 such that the cassette can be pulled out in e.g. frontward direction in FIG. 1.

A sheet transport path 28 is provided along an approximately vertical direction around an end (around a left end in FIG. 1) of the image forming apparatus main body 12. Transport rollers 29, registration rollers 30, a second transfer roller 32, a fixing device 34 and output rollers 36 are provided along the sheet transport path 28. The registration rollers 30 temporarily stop a sheet sent to the sheet transport path 28, and send the sheet to the second transfer roller 32 at predetermined timing. The fixing device 34 having a heat roller 34a and a pressure roller 34b fixes a toner image to the sheet by applying heat and pressure to the sheet passing between the heat roller 34a and the pressure roller 34b.

An output tray 38 is provided in an upper part of the image forming apparatus main body 12. The above-described sheet on which the toner image has been fixed is outputted with the output rollers 36 to the output tray 38, thus stacked on the output tray 38. Accordingly, the sheets in the sheet feed cassette 20 are sequentially passed through the C-shaped path and outputted to the output tray 38.

Plural (e.g. four) toner bottles 40Y, 40M, 40C and 40B used as developing material containers are provided at the other end (right end side in FIG. 1) of the image forming apparatus main body 12. The toner bottle 40Y contains yellow toner; the toner bottle 40M contains magenta toner; the toner bottle 40C contains cyan toner; and the toner bottle 40B contains black toner. The yellow toner is supplied from the toner bottle 40Y to the image forming part 16Y; the magenta toner is supplied from the toner bottle 40M to the image forming part 16M; the cyan toner is supplied from the toner bottle 40C to the image forming part 16C; and the black toner is supplied from the toner bottle 40B to the image forming part 16B, respectively via a supply path formed with a pipe or the like (not shown).

The image forming parts 16Y, 16M, 16C and 16B respectively have an image formation unit 48 provided on one surface of the intermediate transfer belt 14. The image formation units 48 are attachable/removable to/from the image forming apparatus main body 12. For example, the image formation units 48 are once moved downward with respect to the intermediate transfer belt 14, then can be pulled out in the frontward direction in FIG. 1.

The intermediate transfer belt 14 is supported, with a main driving roller 41, an auxiliary driving roller 42 and a tension roller 43 which applies a predetermined tensile force to the intermediate transfer belt 14, so as to be rotated in an arrow direction in FIG. 1. In this manner, in the present exemplary embodiment, the main driving roller 41, the auxiliary driving roller 42 and the tension roller 43 are used as support members to support the intermediate transfer belt 14 used as a conveyance member. Further, the main driving roller 41 and the auxiliary driving roller 42 are also used as driving units to drive the intermediate transfer belt 14. The intermediate transfer belt 14 has a transfer surface 45 in a portion from the tension roller 43 to the main driving roller 41 to transfer images formed by the plural image forming parts 16Y, 16M, 16C and 16B. The transfer surface 45 has a front end P2 used as a transfer entry point and a rear end P1 used as a transfer exit point, and has a slope with respect to a horizontal direction from the front end P2 to the rear end P1.

The main driving roller 41 and the auxiliary driving roller 42 transmit a driving force to the intermediate transfer belt 14 thereby drive the intermediate transfer belt 14 to rotate in the arrow direction in FIG. 1. The auxiliary driving roller 42 is also used as a backup roller provided in a position opposite to the second transfer roller 32. The details of the main driving roller 41 and the auxiliary driving roller 42 will be described later.

The tension roller 43 is connected with an elastic body 46 used as an urging member, and is urged by the elastic body 46 to be moved away from the main driving roller 41 and the auxiliary driving roller 42, thereby applies a tensile force to the intermediate transfer belt 14.

First transfer rollers 50, respectively opposite to the image formation units 48, are provided inside the intermediate transfer belt 14. In the present exemplary embodiment, the first transfer rollers 50 are used as transfer members to transfer toner images formed by the plural image forming parts 16Y, 16M, 16C and 16B onto the intermediate transfer belt 14.

An intermediate transfer belt cleaner 44 is provided on the upper end side of the intermediate transfer belt 14, and the tension roller 43 is used as a backup roller for the intermediate transfer belt cleaner 44.

The intermediate transfer belt 14, the main driving roller 41, the auxiliary driving roller 42, the tension roller 43, the first transfer rollers 50 and the intermediate transfer belt cleaner 44 are integrated as the above-described belt unit 15. The belt unit 15 is attachable/removable to/from the image forming apparatus main body 12, and can be pulled out in the frontward direction in FIG. 1.

The second transfer roller 32 is integrated as a second transfer unit 33. The second transfer unit 33 is attachable/removable to/from the image forming apparatus main body 12, and can be pulled out in the frontward direction in FIG. 1.

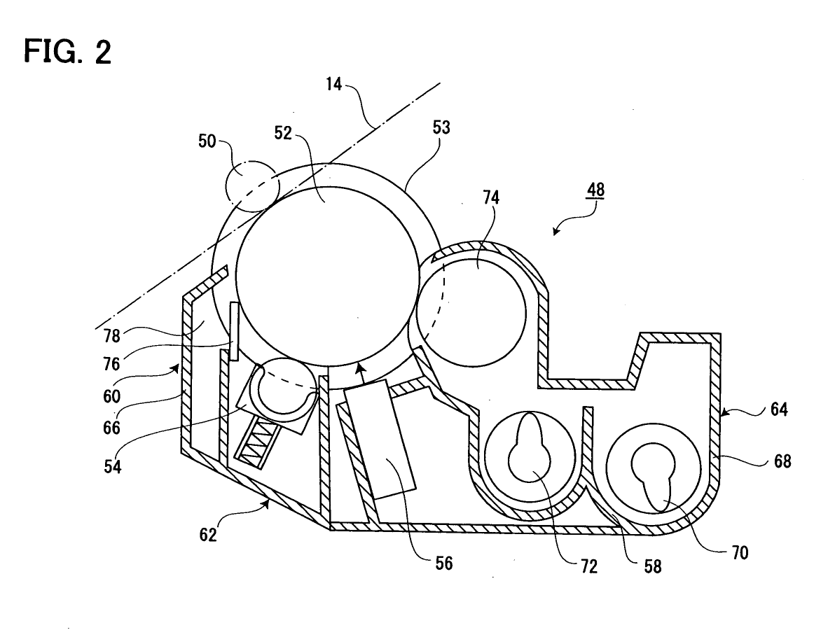

FIG. 2 shows the details of the image forming part 16. Although colors of developing material used in the image forming parts 16Y, 16M, 16C and 16B are different, these image forming parts have the same structure, accordingly, the structure will be described as the image forming part 16. The image forming part 16 has the image formation unit 48. The image formation unit 48 has a photoreceptor 52, a charging device 54 having e.g. a roller to charge the photoreceptor 52, an exposure device 56 having e.g. an LED (light emitting diode) to form a latent image on the photoreceptor 52, a developing device 58 to develop the latent image formed with the exposure device 56 on the photoreceptor 52 using toner, and a cleaner 60 to remove toner remaining on the photoreceptor 52 after transfer. In the present exemplary embodiment, the photoreceptor 52 is used as an image carrier which holds a developing material image transferred onto the intermediate transfer belt 14.

The image formation unit 48 has a photoreceptor unit 62 and a developing unit 64 which separably connected. The photoreceptor unit 62 has the photoreceptor 52, the charging device 54, the exposure device 56 and the cleaner 60 in a first housing 66. The developing unit 64 has the developing device 58 in a second housing 68. The first housing 66 and the second housing 68 are separably connected, thereby the image formation unit 48 is formed.

A bearing 53 to rotatably support the photoreceptor 52 is attached at both ends of the photoreceptor 52 in its lengthwise direction. A part of the bearing 53, along with a part of the photoreceptor 52, is exposed from the first housing 68 and the second housing 68.

The developing device 58 is, e.g. a two-component type unit using toner and carrier for development. For example, the developing device 58 has two augers 70 and 72 parallel in the horizontal direction, and a developing roller 74 provided in a diagonally upper position of the output side auger 72. The toner and carrier are stirred with the augers 70 and 72 and supplied to the developing roller 74. In the developing roller 74, a magnetic brush is formed with the carrier, and the toner attached to the carrier is conveyed by the magnetic brush, and a latent image on the photoreceptor 52 is developed with the toner. In this exemplary embodiment, in the two-component type developing device 58, as the developing roller 74 is provided in the upper position from the augers 70 and 72, retention of the toner and carrier can be prevented. The toner and carrier can be uniformly stirred, and the developing performance can be maintained. The developing device 58 is supplied with toner from the above-described toner bottle 40.

The cleaner 60 has a toner scraper 76 such as a blade and a collection part 78 to collect toner scraped with the toner scraper 76.

In the image forming apparatus 10 having the above configuration, the surface of the photoreceptor 52 is uniformly charged by the charging device 54, and a latent image is written onto the surface of the uniformly charged photoreceptor 52 by the exposure device 56. The latent image is developed by the developing device 58, and a toner image is formed on the surface of the photoreceptor 52. The toner image is transferred onto the intermediate transfer belt 14 with the first transfer rollers 50. The circumferential velocity of the photoreceptor 52 is different from that of the intermediate transfer belt 14 and slower than that of the intermediate transfer belt 14. Accordingly, by the difference between the circumferential velocities of the photoreceptor 52 and the intermediate transfer belt 14, the toner image is scrape-transferred from the surface of the photoreceptor 52 onto the intermediate transfer belt 14.

The toner image transferred onto the intermediate transfer belt 14 and overlaid on the surface of the intermediate transfer belt 14 is transferred with the second transfer roller 32 to the sheet, then the toner image transferred onto the sheet is fixed with the fixing device 34 to the sheet. Then the sheet on which the toner image is fixed is outputted with the output rollers 36 to the output tray 38.

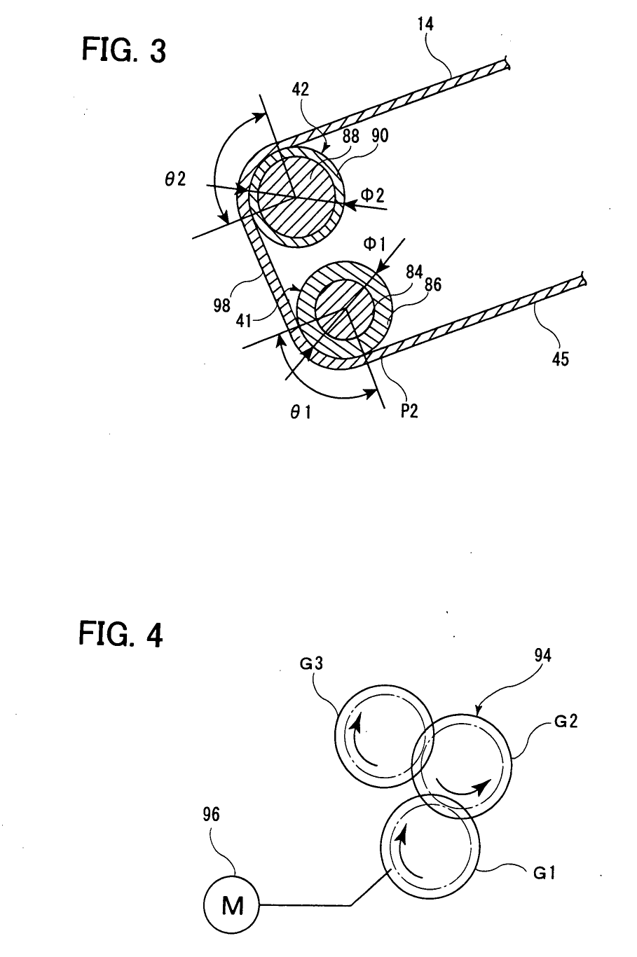

FIG. 3 shows the main driving roller 41 and the auxiliary driving roller 42. The main driving roller 41 has a core 84 of e.g. metal and an outer peripheral member 86 provided around the core 84 so as to cover the core 84. The outer peripheral member 86 is formed of material having a sufficient frictional coefficient such as rubber. The rotation of the main driving roller 41 is transmitted to the intermediate transfer belt 14 via a frictional force caused between the outer peripheral member 86 and the inner surface of the intermediate transfer belt 14, thus the driving force is transmitted from the main driving roller 41 to the intermediate transfer belt 14. The main driving roller 41 has an outer diameter φ1, which is e.g. about 25 mm, and the contact angle θ1 of the intermediate transfer belt 14 with respect to the main driving roller 41 is set to e.g. about 90°.

The auxiliary driving roller 42 has a core 88 of e.g. metal and an outer peripheral member 90 provided around the core 88 so as to cover the core 88. The outer peripheral member 90 is formed of rubber or the like. The outer peripheral member 90 has a frictional coefficient lower than that of the outer peripheral member 86 of the main driving roller 41. Although the frictional coefficient of the outer peripheral member 90 is lower than that of the outer peripheral member 86 of the main driving roller 41, the rotation of the auxiliary driving roller 42 is transmitted to the intermediate transfer belt 14 via a frictional force caused between the outer peripheral member 90 and the inner surface of the intermediate transfer belt 14, thus the driving force is transmitted from the auxiliary driving roller 42 to the intermediate transfer belt 14. Since the frictional coefficient of the outer peripheral member 90 is lower than that of the outer peripheral member 86 of the main driving roller 41, the driving force transmitted to the intermediate transfer belt 14 is smaller than that of the main driving roller 41.

The auxiliary driving roller 42 has an outer diameter φ2, which is set to approximately the same value of that of the main driving roller 41, e.g., about 25 mm. The contact angle θ2 of the intermediate transfer belt 14 with respect to the auxiliary driving roller 42 is set to approximately the same angle of that with respect to the main driving roller 41, e.g. about 90°.

FIG. 4 shows a driving transmission mechanism 94 used as a driving transmission member to transmit driving to the main driving roller 41 and the auxiliary driving roller 42. The driving transmission mechanism 94 has a gear G1, a gear G2 and a gear G3. The gear G1 which is connected to the main driving roller 41 (see FIGS. 1 and 3) transmits driving to the main driving roller 41. The gear G1 is connected to a driving source 96 such as a motor. The gear G1 is rotated in an arrow direction shown in FIG. 4 by the driving transmitted from the driving source 96.

The gear G2, engaged with the gear G1 and the gear G3, is used for transmitting the rotation of the gear G1 to the gear G3. The gear G3 is connected to the auxiliary driving roller 42 (see FIGS. 1 and 3). Accordingly, the gear G3 is rotated by the driving transmitted from the driving source 96 via the gear G1 and the gear G2, to transmit the driving to the auxiliary driving roller 42.

The number of teeth of the gear G3 is smaller than that of the gear G1. For example, when the number of teeth of the gear G1 is 52, the number of teeth of the gear G3 is 50. Accordingly, the angular velocity of the gear G3, i.e., the angular velocity of the auxiliary driving roller 42 is higher than the angular velocity of the gear G1, i.e., the angular velocity of the main driving roller 41. As described above, since the outer diameter φ1 of the main driving roller 41 and the outer diameter φ2 of the auxiliary driving roller 42 are approximately the same, the peripheral velocity of the auxiliary driving roller 42 is higher than that of the main driving roller 41.

As described above, in the present exemplary embodiment, among the support rollers which are used as support members to support the intermediate transfer belt 14, at least two of the rollers, i.e., the main driving roller 41 and the auxiliary driving roller 42, rotate and drive the intermediate transfer belt 14 by the rotate driving via the frictional force.

In a case where the intermediate transfer belt 14 is rotate-driven using two or more i.e. at least two driving rollers, when the driving forces transmitted from the respective driving rollers to the intermediate transfer belt 14 are the same, the driving transmission followed by the rotation of the intermediate transfer belt 14 is not clearly determined, and the rotation of the intermediate transfer belt 14 may become unstable. Accordingly, in the image forming apparatus 10, when the intermediate transfer belt 14 is driven, the frictional coefficient of the outer peripheral member 86 of the main driving roller 41 is higher than that of the outer peripheral member 90 of the auxiliary driving roller 42. The driving force transmitted from the main driving roller 41 to the intermediate transfer belt 14 is greater than that transmitted from the auxiliary driving roller 42 to the intermediate transfer belt 14 to drive the intermediate transfer belt 14.

In a case where the intermediate transfer belt 14 is driven using two or more i.e. at least two driving rollers and the respective driving rollers have different driving forces to be transmitted to the intermediate transfer belt 14, there is a probability that the transfer surface 45 is skewed and transfer of a toner image to the intermediate transfer belt 14 in the transfer surface 45 is not excellently performed in accordance with the set driving forces transmitted from the respective driving rollers to the intermediate transfer belt 14. Accordingly, in the image forming apparatus 10, in a rotational direction of the intermediate transfer belt 14, with the rear end P1 of the transfer surface 45 as a start point, the driving force transmitted from the driving roller to the intermediate transfer belt 14 is increased as the start point is positioned on the upstream side in the rotational direction of the intermediate transfer belt 14, and the driving force transmitted from a driving roller closest to the rear end P1 to the intermediate transfer belt 14 is greater than that transmitted from the other driving rollers to the intermediate transfer belt 14.

In a case where the intermediate transfer belt 14 is driven using two or more, i.e., at least two driving rollers, there is a probability that the transfer surface 45 is skewed in accordance with set peripheral velocities of the respective driving rollers and transfer in the transfer surface 45 is not excellently performed. For example, when the peripheral velocity of the main driving roller 41 and that of the auxiliary driving roller 42 are the same or the peripheral velocity of the auxiliary driving roller 42 is lower than that of the main driving roller 41, a surface 98 (see FIG. 3) of the intermediate transfer belt 14 formed between the main driving roller 41 and the auxiliary driving roller 42 is skewed, and the transfer surface 45 may be skewed due to the influence of the skew of the surface 98. Accordingly, in the image forming apparatus 10, with the rear end P1 of the transfer surface 45 as a start point, the peripheral velocity of the driving roller is increased as the start point is positioned on the upstream side in the rotational direction of the intermediate transfer belt 14, and the peripheral velocity of a driving roller closest to the rear end P1 is lower than that of the other driving rollers.

The peripheral velocity of the auxiliary driving roller 42 is higher than that of the main driving roller 41, and the frictional coefficient of the outer peripheral member 90 of the auxiliary driving roller 42 is lower than that of the outer peripheral member 86 of the main driving roller 41. Accordingly, the auxiliary driving roller 42 transmits the driving to the intermediate transfer belt 14 while slipping in a contact portion with the intermediate transfer belt 14. Further, the auxiliary driving roller 42 slips in the contact portion with the intermediate transfer belt 14, thereby applies the driving force to the intermediate transfer belt 14 while limiting the driving force.

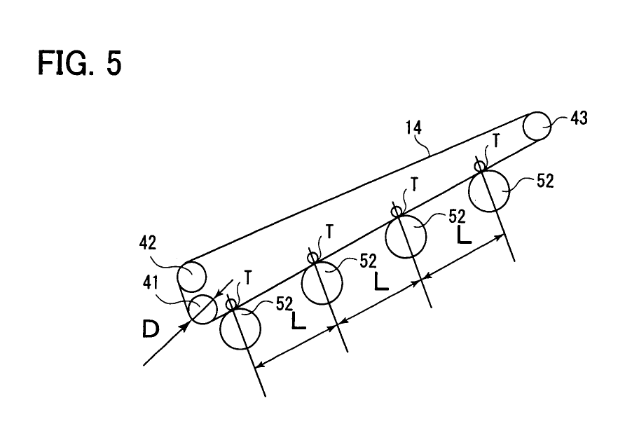

FIG. 5 shows the relation between a distance L between transfer positions T in which the mutually adjacent first transfer rollers 50 perform transfer, and the circumference (rotational perimeter) of the main driving roller 41 with a driving force greater than that of the auxiliary driving roller 42. In the image forming apparatus 10, assuming that the outer diameter of the main driving roller 41 is D, the circumference π·D of the main driving roller 41 and the interval L are approximately equal. For example, even when rotational unevenness of the main driving roller 41 occurs due to eccentricity of the main driving roller 41 and periodical variation occurs in the peripheral velocity of the intermediate transfer belt 14, expansion and contraction of toner images transferred from the respective photoreceptors 52 onto the surface of the intermediate transfer belt 14 corresponds with each other on the intermediate transfer belt 14. Further, it may be arranged such that the interval L is an integral multiple of the circumference π·D such as approximate twice or thrice, instead of setting the circumference π·D and the interval L to approximately the same, i.e., setting the interval L to approximately the equal value.

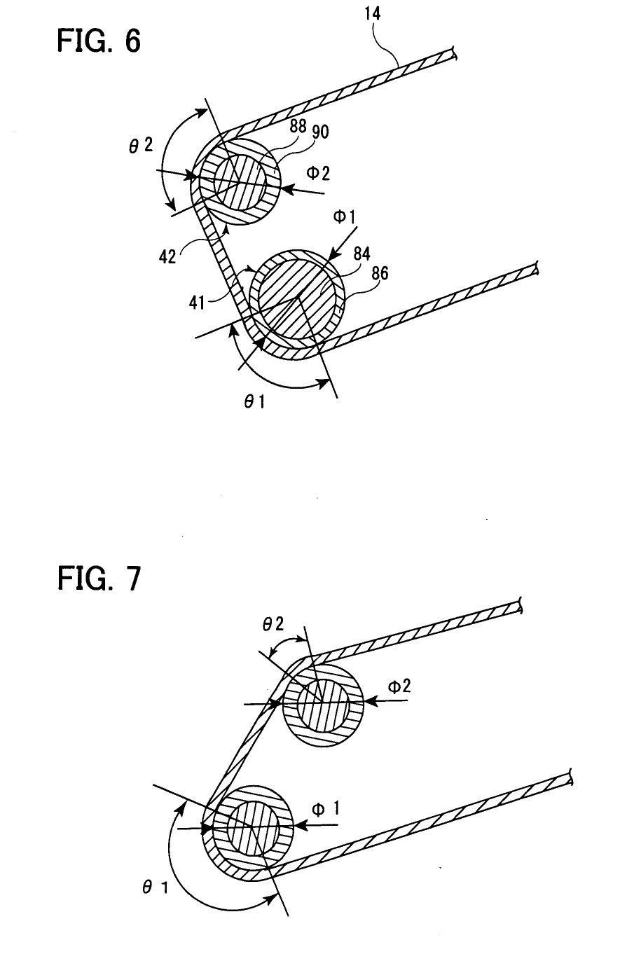

FIG. 6 shows the main driving roller 41 and the auxiliary driving roller 42 of the image forming apparatus according to a second exemplary embodiment of the present invention. In the first exemplary embodiment, the outer diameter φ1 of the main driving roller 41 and the outer diameter φ2 of the auxiliary driving roller 42 are approximately the same, whereas in the second exemplary embodiment, the outer diameter φ1 of the main driving roller 41 is larger than the outer diameter φ2 of the auxiliary driving roller 42. For example, when the outer diameter φ2 is 20 mm, the outer diameter φ1 is 25 mm. Further, in the first exemplary embodiment, the frictional coefficient of the outer peripheral member 86 of the main driving roller 41 is higher than that of the outer peripheral member 90 of the auxiliary driving roller 42, whereas in the second exemplary embodiment, the frictional coefficient of the outer peripheral member 86 and that of the outer peripheral member 90 are approximately the same.

As in the case of the first exemplary embodiment, the peripheral velocity of the main driving roller 41 and that of the auxiliary driving roller 42 are set such that the peripheral velocity of the main driving roller 41 is higher than that of the auxiliary driving roller 42. In this case, the number of teeth of the gear G1, that of the gear G2 and that of the gear G3 (FIG. 4) are set such that the peripheral velocity of the auxiliary driving roller 42 is higher than that of the main driving roller 41 by a desired value in accordance with the difference between the outer diameter of the main driving roller 41 and the outer diameter of the auxiliary driving roller 42.

As in the case of the first exemplary embodiment, the contact angle θ1 of the intermediate transfer belt 14 with respect to the main driving roller 41 and the contact angle θ2 of the intermediate transfer belt 14 with respect to the auxiliary driving roller 42 are approximately the same, i.e., about 90°.

In the second exemplary embodiment, the angle θ1 and the angle θ2 are approximately the same. However, since the outer diameter φ1 is larger than the outer diameter φ2, an area of the main driving roller 41 in contact with the intermediate transfer belt 14 is larger than that of the auxiliary driving roller 42 in contact with the intermediate transfer belt 14. Since the outer peripheral member 86 and the outer peripheral member 90 have approximately the same frictional coefficients, the driving force transmitted from the main driving roller 41 to the intermediate transfer belt 14 is larger than that transmitted from the auxiliary driving roller 42 to the intermediate transfer belt 14. Further, the auxiliary driving roller 42 transmits driving to the intermediate transfer belt 14 while slipping on the intermediate transfer belt 14 since the area of the auxiliary driving roller 42 in contact with the intermediate transfer belt 14 is comparatively small.

It may be arranged such that, as a combination of the second exemplary embodiment and the first exemplary embodiment, the outer diameter φ2 of the auxiliary driving roller 42 is smaller than the outer diameter φ1 of the main driving roller 41, and the frictional coefficient of the outer peripheral member 90 of the auxiliary driving roller 42 is lower than that of the outer peripheral member 86 of the main driving roller 41. Note that the explanations of the other parts corresponding to those in the first exemplary embodiment will be omitted.

FIG. 7 shows the main driving roller 41 and the auxiliary driving roller 42 of the image forming apparatus according to a third exemplary embodiment of the present invention. In the first exemplary embodiment, the contact angle θ1 of the intermediate transfer belt 14 with respect to the main driving roller 41 and the contact angle θ2 of the intermediate transfer belt 14 with respect to the auxiliary driving roller 42 are approximately the same, i.e., about 90°. In the third exemplary embodiment, the angle θ1 is larger than the angle θ2, i.e., the angle θ1 is about 135°, and the angle θ2, about 35°. As in the case of the first exemplary embodiment, the outer diameter φ1 of the main driving roller 41 and the outer diameter φ2 of the auxiliary driving roller 42 are approximately the same, i.e., 25 mm. Further, as in the case of the first exemplary embodiment, the frictional coefficient of the outer peripheral member 86 of the main driving roller 41 and that of the outer peripheral member 90 of the auxiliary driving roller 42 are approximately the same. Further, as in the case of the first exemplary embodiment, the peripheral velocity of the main driving roller 41 and that of the auxiliary driving roller 42 are set such that the peripheral velocity of the auxiliary driving roller 42 is higher than the peripheral velocity of the main driving roller 41.

In the third exemplary embodiment, the outer diameter φ1 and the outer diameter φ2 are approximately the same, however, the angle θ1 is larger than the angle θ2. Accordingly, the area of the main driving roller 41 in contact with the intermediate transfer belt 14 is larger than the area of the auxiliary driving roller 42 in contact with the intermediate transfer belt 14. Since the frictional coefficient of the outer peripheral member 86 and that of the outer peripheral member 90 are approximately the same, the driving force transmitted from the main driving roller 41 to the intermediate transfer belt 14 is larger than that transmitted from the auxiliary driving roller 42 to the intermediate transfer belt 14. Further, as in the case of the first and second exemplary embodiments, the auxiliary driving roller 42 transmits driving to the intermediate transfer belt 14 while slipping on the intermediate transfer belt 14 since the area of the auxiliary driving roller 42 in contact with the intermediate transfer belt 14 is comparatively small.

It may be arranged such that the third exemplary embodiment is combined with at least one of the first and second exemplary embodiments. Note that the explanations of the other parts corresponding to those in the first exemplary embodiment will be omitted.

In the above-described first to third exemplary embodiments, the intermediate transfer belt 14 is driven with two driving rollers, the main driving roller 41 and the auxiliary driving roller 42. However, the intermediate transfer belt 14 may be driven using three or more driving rollers. For example, the tension roller 43 may be used as a driving roller in addition to the main driving roller 41 and the auxiliary driving roller 42, such that the intermediate transfer belt 14 is driven with three driving rollers. In this case, the driving force transmitted from the tension roller 43 to the intermediate transfer belt 14 is smaller than that of the auxiliary driving roller 42 smaller than that of the main driving roller 41. Further, the peripheral velocity of the tension roller 43 is set to be lower than that of the auxiliary driving roller 42 lower than that of the main driving roller 41.

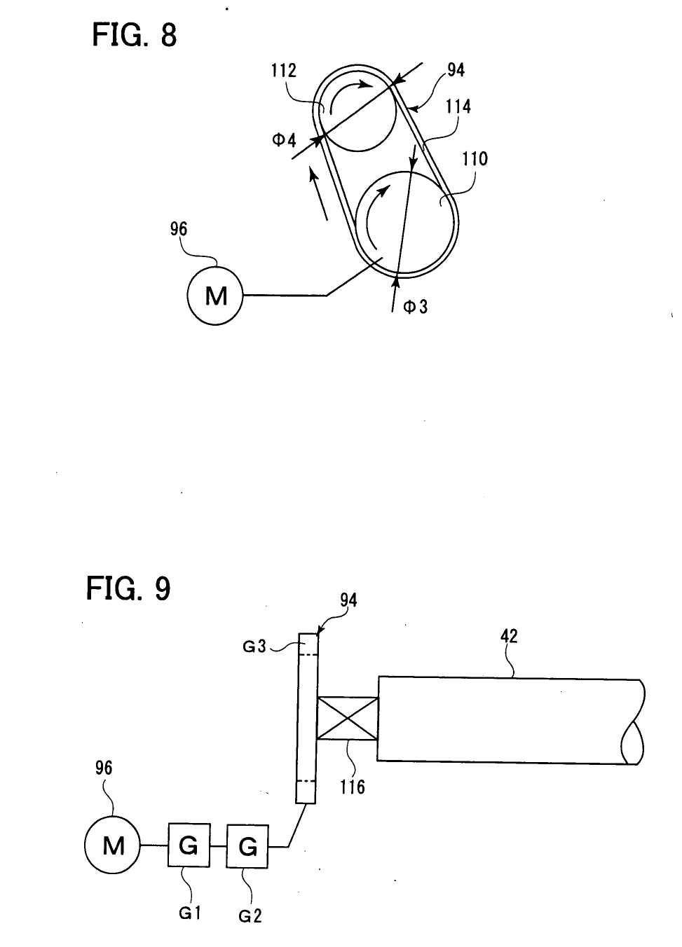

FIG. 8 shows the driving transmission mechanism 94 of the image forming apparatus according to a fourth exemplary embodiment of the present invention. In the first exemplary embodiment, the driving transmission mechanism 94 transmits the driving from the driving source 96 to the main driving roller 41 and the auxiliary driving roller 42 using the gears G1, G2 and G3, whereas in the fourth exemplary embodiment, the driving transmission mechanism 94 transmits driving from the driving source 96 to the main driving roller 41 and the auxiliary driving roller 42 using a pulley 110, a pulley 112 and a belt 114.

The pulley 110 which is connected to the main driving roller 41 transmits driving to the main driving roller 41. The pulley 110 is connected with the driving source 96, and is rotated in an arrow direction in FIG. 8 with driving transmission from the driving source 96. The belt 114, formed of e.g. a rubber ring, is attached around the pulley 110 and the pulley 112. The belt 114 transmits driving from the pulley 110 to the pulley 112. As the belt 114 of rubber or the like has a sufficient frictional coefficient, the belt 114 excellently transmits the driving from the pulley 110 to the pulley 112 by a frictional force. However, slipping occurs in a position between the pulley 110 and the belt 114 and in a position between the pulley 112 and the belt 114.

The pulley 112 is connected to the auxiliary driving roller 42. The outer diameter φ4 of the pulley 112 is smaller than the outer diameter φ3 of the pulley 110. Accordingly, the angular velocity of the pulley 112 i.e. the angular velocity of the auxiliary driving roller 42 is higher than the angular velocity of the pulley 110 i.e. the angular velocity of the main driving roller 41. As in the case of the first exemplary embodiment, since the outer diameter φ1 of the main driving roller 41 and the outer diameter φ2 of the auxiliary driving roller 42 are approximately the same, the peripheral velocity of the auxiliary driving roller 42 is higher than the peripheral velocity of the main driving roller 41.

In the first to third exemplary embodiments, as slipping is caused between the auxiliary driving roller 42 and the intermediate transfer belt 14, the auxiliary driving roller 42 transfers the driving force to the intermediate transfer belt 14 while limiting the driving force. In the fourth exemplary embodiment, the driving transmission mechanism 94 transmits the driving to the auxiliary driving roller 42 while limiting the driving force by causing slipping in the position between the pulley 110 and the belt 114 and the position between the pulley 112 and the belt 114. Note that the explanations of the other parts corresponding to those in the first exemplary embodiment will be omitted.

FIG. 9 shows the driving transmission mechanism 94 of the image forming apparatus according to a fifth exemplary embodiment of the present invention. In the first exemplary embodiment, the gear G3 and the auxiliary driving roller 42 are connected in e.g. a direct manner, so as to prevent a loss in the driving transmission between the gear G3 and the auxiliary driving roller 42. In the fifth exemplary embodiment, a torque limiter 116 is provided between the gear G3 and the auxiliary driving roller 42. The driving transmission is performed from the gear G3 via the torque limiter 116 to the auxiliary driving roller 42. The torque limiter 116 is used for limiting the torque transmitted from the gear G3 to the auxiliary driving roller 42 such that the driving force transmitted from the auxiliary driving roller 42 to the intermediate transfer belt 14 is smaller than the driving force transmitted from the main driving roller 41 to the intermediate transfer belt 14. In the fifth exemplary embodiment, as in the case of the fourth exemplary embodiment, the driving transmission mechanism 94 transmits the driving from the driving source to the auxiliary driving roller 42 while limiting the driving force. Note that the explanations of the other parts corresponding to those in the first exemplary embodiment will be omitted.

In the above-described fourth and fifth exemplary embodiments, the intermediate transfer belt 14 is driven with the two driving rollers, the main driving roller 41 and the auxiliary driving roller 42. However, the intermediate transfer belt 14 may be driven with three or more driving rollers. For example, the tension roller 43 may be used as a driving roller in addition to the main driving roller 41 and the auxiliary driving roller 42, such that the intermediate transfer belt 14 is driven with three driving rollers. In this case, the driving transmission mechanism 94 transmits the driving to the tension roller 43 while limiting the driving force.

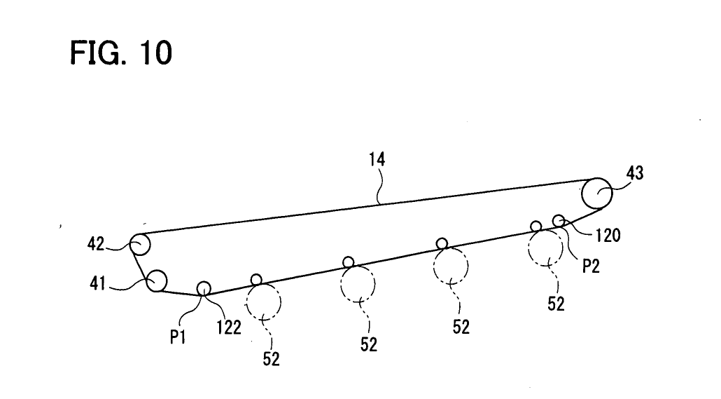

FIG. 10 shows the intermediate transfer belt 14 supported in the image forming apparatus according to a sixth exemplary embodiment of the present invention. In the first to fifth exemplary embodiments, the intermediate transfer belt 14 is supported with three rollers, i.e., the main driving roller 41, the auxiliary driving roller 42 and the tension roller 43. In the sixth exemplary embodiment, the intermediate transfer belt 4 is supported with five rollers, i.e., an entry point side surface roller 120 and an exit point side surface roller 122 in addition to the main driving roller 41, the auxiliary driving roller 42 and the tension roller 43. Note that the explanations of the other parts corresponding to those in the first exemplary embodiment will be omitted.

The entry point side surface roller 120 and the exit point side surface roller 122 are used for excellent formation of the transfer surface 45 for transfer of toner images from the photoreceptors 52 to the intermediate transfer belt 14. The entry point side surface roller 120 is provided on the backside of the front end P2 of the transfer surface 45, and the exit point side surface roller 122 is provided on the backside of the rear end P1 of the transfer surface 45. Note that the explanations of the other parts corresponding to those in the first exemplary embodiment will be omitted.

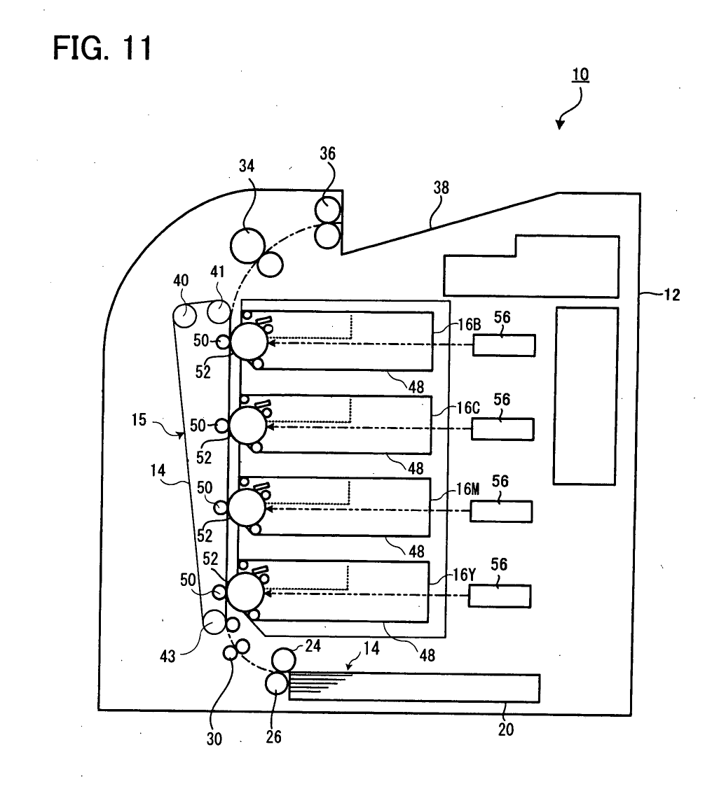

FIG. 11 shows the image forming apparatus 10 according to a seventh exemplary embodiment of the present invention. In the first to sixth embodiments, the image forming apparatus 10 has the intermediate transfer belt 14 as a conveyance member, and the intermediate transfer belt 14 conveys the toner images formed by the image forming parts 16Y, 16M, 16C and 16B. In the seventh exemplary embodiment, the image forming apparatus 10 has a sheet conveyance belt 14 in place of the intermediate transfer belt.

In the seventh exemplary embodiment, the sheet conveyance belt 14 is used as a conveyance member to convey a sheet, on which images formed by the plural image forming parts 16Y, 16M, 16C and 16B are transferred. The sheet conveyance belt 14 conveys a sheet fed from the sheet feeder 18 from a lower position to an upper position in a gravitational direction. Note that the explanations of the other parts corresponding to those in the first exemplary embodiment will be omitted.

As described above, the present invention is applicable to a conveyance apparatus having a conveyance member such as an intermediate transfer belt, a sheet conveyance belt, or a photoreceptor belt and an image forming apparatus having the conveyance apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A conveyance apparatus comprising:
a conveyance member that conveys images formed by a plurality of image forming parts or a recording medium on which the images formed by the plurality of image forming parts are transferred; and
a driving unit that drives the conveyance member via a frictional force in at least two positions.

2. A conveyance apparatus comprising:
a conveyance member that conveys images formed by a plurality of image forming parts or a recording medium on which the images formed by the plurality of image forming parts are transferred; and
a plurality of support members that support the conveyance member,
at least two of the plurality of support members rotating and driving the conveyance member via a frictional force.

3. The conveyance apparatus according to claim 2, wherein one of the support members that drive the conveyance member has a driving force larger than driving forces of the other support members.

4. The conveyance apparatus according to claim 2,
wherein the conveyance member has a transfer surface formed thereon to transfer the images by the image forming parts to the conveyance member or the recording medium conveyed by the conveyance member,
the transfer surface has a transfer entry point and a transfer exit point, and
a circumferential velocity of one of the support members that drive the conveyance member, closest to the exit point, is lower than circumferential velocities of the other support members.

5. The conveyance apparatus according to claim 2,
wherein the conveyance member has a transfer surface formed thereon to transfer the images by the image forming parts to the conveyance member or the recording medium conveyed by the conveyance member,
the transfer surface has a transfer entry point and a transfer exit point, and
an area of one of the support members that drive the conveyance member, closest to the exit point, in contact with the conveyance member, is larger than areas of the other support members in contact with the conveyance member.

6. The conveyance apparatus according to claim 2,
wherein the conveyance member has a transfer surface formed thereon to transfer the images by the image forming parts to the conveyance member or the recording medium conveyed by the conveyance member,
the transfer surface has a transfer entry point and a transfer exit point, and
at least a surface frictional coefficient of one of the support members that drive the conveyance member, closest to the exit point, is higher than surface frictional coefficients of the other support members.

7. A conveyance apparatus comprising:
a conveyance member that conveys images formed by a plurality of image forming parts or a recording medium on which the images formed by the plurality of image forming parts are transferred; and
a plurality of support members that support the conveyance member,
at least two of the plurality of support members rotating and driving the conveyance member via a frictional force,
one of the support members that drive the conveyance member having a driving force larger than driving forces of the other support members,
a transfer surface formed on the conveyance member to transfer the images by the plurality of image forming parts to the conveyance member or the recording medium conveyed by the conveyance member,
the transfer surface having a transfer entry point and a transfer exit point, and
a driving force of one of the support members that drive the conveyance member, closest to the exit point, being larger than driving forces of the other support members.

8. An image forming apparatus comprising:
a plurality of image forming parts;
a plurality of transfer units that respectively transfer images formed by the plurality of image forming parts;
a conveyance member that conveys the images transferred by the plurality of transfer units or a recording medium on which the images are transferred by the plurality of transfer units; and
a driving unit that drives the conveyance member via a frictional force in at least two positions.

9. An image forming apparatus comprising:
a plurality of image forming parts;
a plurality of transfer units that respectively transfer images formed by the plurality of image forming parts;
a conveyance member that conveys the images transferred by the plurality of transfer units or a recording medium on which the images are transferred by the plurality of transfer units; and
a plurality of support members that support the conveyance member,
at least two of the plurality of support members rotating and driving the conveyance member via a frictional force.

10. The image forming apparatus according to claim 9, wherein among the plurality of transfer units, a distance between transfer positions of adjacent transfer units is an approximately integral multiple of a rotational perimeter of one of the plurality of support members having a driving force larger than driving forces of the other support members.

11. The image forming apparatus according to claim 8,
wherein the plurality of image forming parts have respective image carriers that carry the images to be transferred to the conveyance members or the recording medium conveyed by the conveyance members, and
the image carriers have a circumferential velocity different from a circumferential velocity of the conveyance member.
